(19) United States
(12) Patent Application Publication
(10) Pub. No.: US 2015/0049864 A1
(43) Pub. Date: Feb. 19, 2015

(54) PRE-INSTALLATION FREQUENCY DOMAIN PREMISES WIRING TESTS

(71) Applicant: Roger Faulkner, Swindon (GB)

(72) Inventor: Roger Faulkner, Swindon (GB)

(21) Appl. No.: 14/461,787

(22) Filed: Aug. 18, 2014

Related U.S. Application Data
(60) Provisional application No. 61/867,407, filed on Aug. 19, 2013.

(51) Int. Cl. H04M 3/08; H04M 3/24

(52) U.S. Cl. CPC H04M 3/085; H04M 3/24
USPC 379/22.03

(57) ABSTRACT

A system and method for testing lines to determine service-affecting conditions on a line, such as telephone wiring. Conditions may be identified from low frequency variations in a frequency spectrum measured on the line. The line may be stimulated with a broad spectrum signal, such as may be generated by a DSL modem operating in the L0 state or may be the result of noise on the line. Analysis of the low frequency variations may yield information about the nature of service-affecting conditions allowing conditions, such as un-terminated or poorly-terminated extensions to be identified. The method may be performed by a test device attached to premises wiring in a telephone network and used to determine whether the premises wiring will support VDSL2 or other high speed data services without modification or may indicate changes at the premises to enable the wiring to support high speed data services.

### RELATED APPLICATION

This application claims priority under 35 U.S.C. §119(e) to U.S. Provisional Application Ser. No. 61/867,407, entitled “Pre-Installation Frequency Domain Premises Wiring Test,” filed on Aug. 19, 2013, which is herein incorporated by reference in its entirety.

### DISCUSSION OF RELATED ART

This application relates to generally to measurement techniques and more specifically to measurement techniques for detecting and/or localizing service-affecting conditions in telephone lines within a premises.

Telephone companies would like to offer their customers high speed data services using existing voice telephone wiring. However, these high-speed data services, because they operate at different frequencies than conventional voice services, are susceptible to service-affecting conditions on the wiring that would not impact conventional voice services or even lower speed data services. To ensure the high-speed data services operate correctly in each customer premises at which they are installed, a telephone company may have a relatively complex installation process for the high-speed data services.

The installation process may include pre-installation testing to determine whether wiring running to a premises is suitable for carrying signals needed to support high-speed data services. Such testing may be conducted using a test head a telephone company might have installed in its network for detecting many types of faults. For pre-installation testing, the test head may use a measurement approach called “reflectometry.” Reflectometry may be time domain or frequency domain reflectometry.

In the time domain, a short pulse is transmitted from the test head. Conditions on a line that would likely interfere with high-speed data services will cause a portion of the pulse to be reflected back to the test head. By detecting a reflected pulse, the test head may determine that a particular line has a condition that needs to be remedied before the line is used to supply high-speed data services.

Frequency domain reflectometry works in an analogous way. Rather than transmitting a short pulse, the transmitted test signal has a range of frequencies. Certain service-affecting conditions will impact some frequencies differently than others. To determine the impact of conditions on the line, frequencies on the line coherent with the transmitted signal are measured at the test head. By analyzing this measured spectrum of frequencies that results from the applied test signal, information on what service-affecting conditions are present on the line may be obtained.

Both time domain and frequency domain reflectometry have been incorporated into test heads used by telephone companies. In addition, the ability to perform frequency domain reflectometry measurements has been incorporated into some modems installed at the telephone company central offices to provide a form of high-speed data services called ADSL.

However, these techniques are not effective for determining whether wiring inside the customer's premises are suitable for high-speed data services, particularly newer versions that operate at very high frequencies, such as VDSL2 services that operate at frequencies up to 30 MHz. Test heads installed in a telephone network generally cannot reliably measure conditions within a customer's premises. Though test equipment to perform time domain frequency domain reflectometry measurements can be taken to the customer premises, such test equipment is generally expensive. A technician installing high-speed data services and a customer's premises may not have such equipment or may not have the skill set necessary to interpret the measurements made by that equipment.

Rather, a known installation process may entail removing existing premises wiring and reinstalling wiring suitable for high-speed data services. An installation process may also entail ensuring that all extensions that are not removed have high-quality modern telephones, which are less likely to interfere with high-speed data services, connected to them. Such an installation process is, unfortunately, time-consuming and expensive for the telephone company.

### BRIEF DESCRIPTION OF DRAWINGS

FIG. 1 illustrates a building provided with a communication service, in which a test device may be used to test conductors used in providing the communication service.

FIG. 2 shows a system in which a test device on the customer's premises is connected to a service provider's network.

FIG. 3 shows an example of a test device configured to test an electrical characteristic of a conductor in the customer's structure, according to some embodiments.

FIG. 4A is a conceptualized sketch of a frequency spectrum of a stimulus signal for testing according to some embodiments.

FIG. 4B is a conceptualized sketch of a frequency spectrum of a measured signal in a scenario in which no premises of faults is present, according to some embodiments.

FIG. 4C is a conceptualized sketch of a frequency spectrum of the measured signal in this scenario in which a premises fault is present, according to some embodiments.

FIG. 5A is a sketch illustrating a comparison of a measured signal when a stimulus signal is present and a measured signal in the presence of noise, without a stimulus signal, in this scenario in which a premises fault is present.

FIG. 5B is a sketch illustrating a measured signal in a scale different than in FIG. 5A.

FIG. 6 is a flowchart of a method of testing premises wiring in accordance with some arguments.

FIG. 7 is a conceptual block diagram of a computing device in which portions of a testing method as described herein may be performed.

### DETAILED DESCRIPTION

The inventor has recognized and appreciated that effective and low cost pre-installation testing to determine the suitability of premises wiring for high speed data services may be performed with a device on premises suitable for measuring the frequency content of signals. Suitable measurements may be made even without determining coherence with any stimulus signal. In some embodiments, the analysis may be made on measurements of noise that is present on the line. The noise may be naturally present, which is not introduced for testing. As a result, such techniques may be implemented within an on-premises test device that might be installed in a customer's premises for testing conventional telephone wiring, lower speed data services or other conditions that may be unrelated to high speed data services, such as VDSL2. Though, the specific device making the measurements is not a limitation on the invention.

Though such testing may be based on a remotely generated stimulus signal, such testing does not require either a remotely generated signal or the presence of a device, such as a modem for high speed data services, to already be installed. As a result, such testing may be performed prior to an installation process to determine whether wiring in a premises needs to be removed or terminated to support high speed data services to be installed.

As a specific example, a customer's premises may be previously provisioned with a lower speed data service, such as ADSL data services. That customer may desire to have higher speed data services from the telephone company, such as VDSL2. Before dispatching a technician to install VDSL2 services, the telephone company may access data collected by a device operating as an on-premises test device for ADSL service. Based on an analysis of that data, the telephone company may determine whether any changes to the premises wiring are required and, if so, the extent of those changes.

Any suitable use of this data may be made. As an example, when analysis of the measurements does not indicate that changes are required to the premises wiring, the telephone company might opt to enlist the customer to attempt a self-install process for a data service. Alternatively or additionally, when the analysis indicates that there are extensions that require termination, the telephone company may send instructions and/or components for terminating those extensions. In this way, a simple self-install process may be provided for some customers. Conversely, when analysis indicates some wiring is ill-suited for high speed data services, the telephone company may dispatch a technician prepared to make the required changes.

Accordingly, in some embodiments, test techniques as described herein may be used as part of a line qualification process. Results of the tests may be used, for example, to disqualify a line, at least in its existing state, from use for particular data services or for self-install of those data services. Such embodiments may entail use of measurement equipment in which the bandwidth over which measurements are made is less than the bandwidth used by the particular data services. As a specific example, an ADSL modem, which operates over a narrower frequency range than ADSL2, may be used to take measurements used to disqualify a line for ADSL2 services or disqualify it for self-install services. In other embodiments, different or additional information may be obtained, such as measurements over the entire frequency spectrum used by a particular data service of interest or an even wider spectrum. In those scenarios, obtained measurements may be used to qualify a line for those data services. As a specific example, a separate test device, which operates over a frequency range of at least 30 MHz, may be used to take measurements that can be used to qualify a line for ADSL2 services.

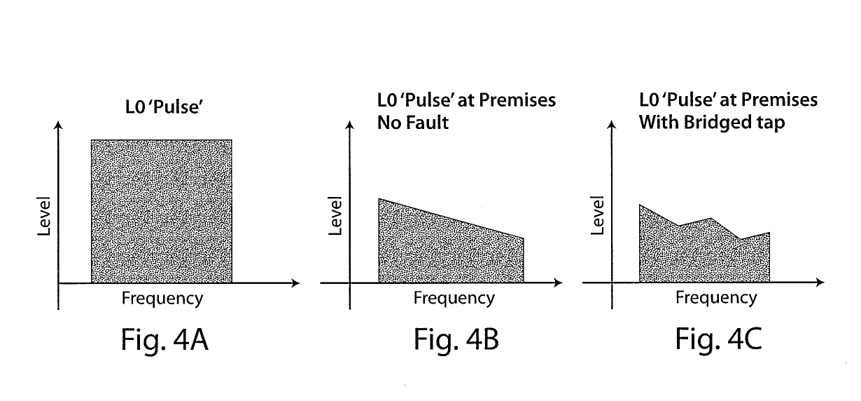

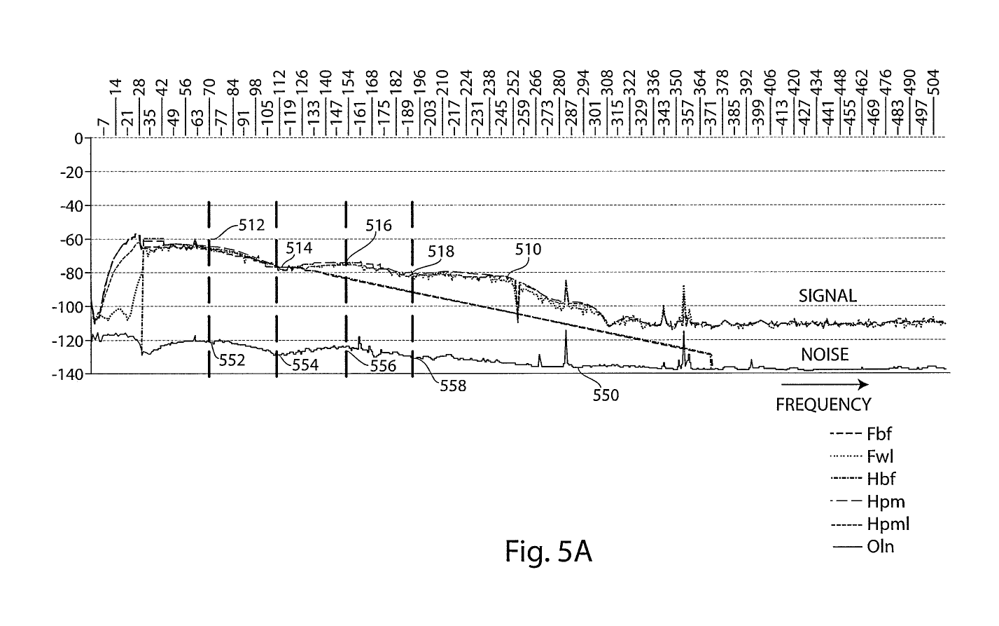

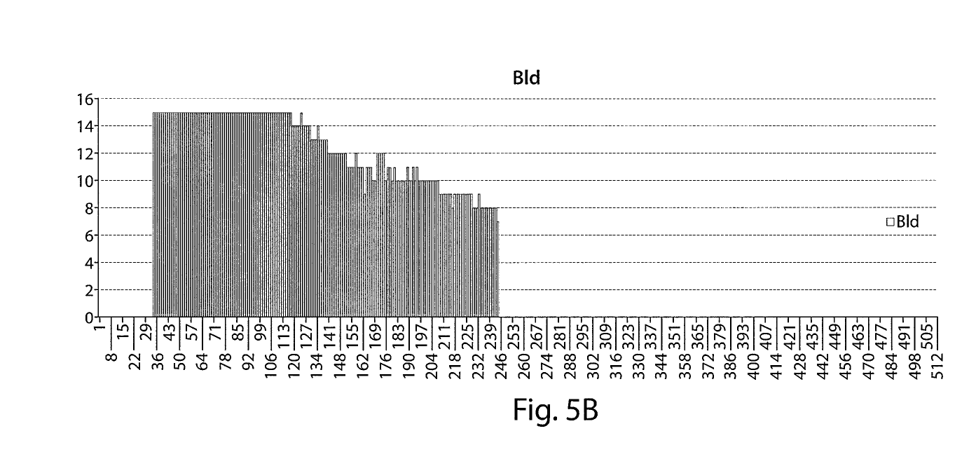

In some embodiments, such a test technique may entail measuring a broad-band signal on a line and analyzing variations, as a function of frequency, of the frequency spectrum of the signal. The broad-band signal may extend over the frequency range of signals to be used in providing a contemplated high speed digital service. The inventor has recognized and appreciated that low frequency variations across the frequency spectrum may indicate conditions of the wiring within the premises, such as the presence of an un-terminated or poorly terminated extension within the premises. In some embodiments, variation in measured amplitude of a stimulus, which may be an intentionally imposed signal or naturally occurring noise, at specific related frequencies, may be used as an indicator of such conditions. If the measured amplitude is invariant over time, creating the appearance of a standing wave (or stationary wave) as illustrated in FIGS. 4C and 5B, information about the condition may be derived from characteristics of the standing wave. Further analysis of the frequency variations, in some embodiments, may indicate whether the conditions within the premises are likely to be service-affecting such that an assessment may be made of whether changes to the premises wiring should be made to support high speed data services.

The measurements to support such an assessment may be made with any suitable test hardware. Likewise, measured data may be analyzed in any suitable computing hardware, which may be within the same device that makes the measurements or in any other device that is capable of communicating directly or indirectly with the test hardware so that measurement data may be accessed and analyzed.

In the description below, a test device positioned at the customer's location within the customer's premises is used as an example of a device that may both make and analyze measurements. In some embodiments, the test device may be connected easily by the customer within the customer's home, such as by using standard telephone connectors, such as telephone a plug or jack. Such a connection may be made, for example, through a broadband connector to the telephone wiring without intermediate filtering devices, such as the low pass side of a telephone splitter. The test device can test wires (or other electrical conductors) carrying service at the customer's location, including conductors on the customer premises and/or outside of the customer premises (e.g., in the service provider network) to enable detecting faults or other problems that may cause a service disruption. Such a device may support multiple operating modes to facilitate multiple modes of identifying conditions that could create service problems, for current or possible future services.

The test device may make any of a variety of measurements and generate any of a variety of test signals, including for reasons unrelated to pre-installation testing for high speed data services. Supported measurements may include measurements of electrical properties of the conductors themselves. These measurements may be used to determine conditions of conductors, such as whether there are un-terminated extensions likely to impact high speed data services as well as faults, such as shorts, opens or conditions causing imbalance of conductors used as a differential pair. These measurements may also be used to determine operational state of conductors, such as whether the conductors are actively being used to provide telephone service or data service.

Other measurements may reveal energy at different frequencies. Such a capability may be used, in combination with an ability to determine whether a line is actively in use, to measure quiet line noise. As a further example, such a capability may be used to determine whether signals in accordance with a protocol, such as DSL, are being received, which can be used to detect or localize faults. Further, using techniques as described below, measurements that reveal energy at different frequencies may be analyzed to determine whether existing wiring is suitable for use in providing higher speed data services than are currently operating within the premises.

Embodiments of the test device described herein may be able to measure parameters that are useful in testing various aspects of conductors present at a customer premises, including a physical network layer of a network within the customer's residence (or other structure). For example, the test device may perform electrical tests on any suitable electrical conductors (e.g., wiring, cables, etc.) within the structure and may be configured to derive, based on those measurements, conclusions about faults or other service-affecting conditions on those conductors. In the embodiments described herein, a test device may be configured to perform tests on telephone lines, cable television wiring, or power lines, for example. Such tests may assist in resolving problems with DSL service, cable television and/or Internet service, a power line communication network, or any other suitable type of service.

Such a test device may be triggered to perform tests in one or more ways. The test device, for example, may be activated by the customer, e.g., by the push of a button, thus enabling the customer to initiate a test without requiring the customer to contact the service provider. Alternatively or additionally, the test device may be activated by an external computing device.

The external computing device may be a computing device operated by the customer. Such a computing device may be programmed to control the test device to perform a diagnostic sequence aimed at identifying faults in conductors on the premises. The diagnostic sequence may include instructions for the user to take action that can aid in diagnosing or, in some scenarios, resolving service-affecting conditions within the customer's premises. In some embodiments, the external computing device that triggers one or more tests may be a DSL modem, router, residential gateway or other customer premises equipment such as a set top box, television, personal computer, tablet computer, smartphone or other device.

Alternatively or additionally, the external computing device may be a computing device operated by the service provider. The external computing device, for example, may be a component of a test system that is testing a line used by a customer having the test device. Interactions between the service provider test system and the test device on the customer premises may better diagnose a fault and determine its location than either the test system or test device alone. Alternatively or additionally, the external computing device may be a computing device managing interactions with a customer that has contacted the service provider for assistance in resolving a problem with service.

In such a scenario, the external computing device may trigger the test device to perform tests or to provide the results of tests. Though, it is not a requirement that the external computing device trigger either the generation or transmission of test results by the test device. The test device, for example, may be programmed to initiate communication with the external computing device based on measurements made in performing a test or may be triggered to initiate communication based on user input or other factors.

In some embodiments, communication, conveying commands, test results or other information may occur over a communication network, which may be the same network providing the communication service or a different network. In the case of a DSL service provider, the communications may be “in-band,” which in that scenario may occur using signaling tones sent as part of a telephone signal, or may be “out of band,” which in that scenario may occur using an Internet service to connect to a web site. Though, it is not a requirement of the invention that such communication between a test device and an external computing device take place electronically or even provided to an external computing device at all. In some embodiments, the test device may have a user interface. A test result can be provided to the customer through the user interface to allow the customer to determine the status of the electrical conductors in their home, and can allow the customer to troubleshoot and resolve problems on their own.

Alternatively or additionally, in some embodiments, a customer may obtain the test result through the user interface and input the test result to an external computing device, such as the customer's computing device. In this way, the external computing device may provide the customer with additional information regarding the test result and/or troubleshooting information. In this manner, detailed guidance may be presented to the customer to assist the customer to resolve the problem.

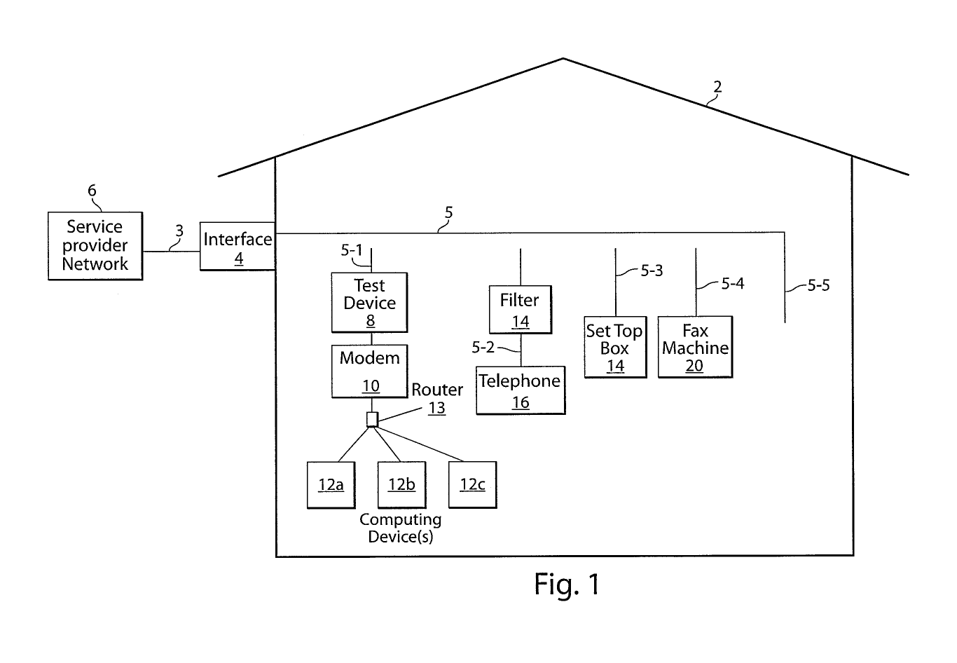

The test devices described herein may be simple and inexpensive, facilitating widespread use by customers and allowing service providers to decrease the cost associated with customer support calls and technician visits. In some embodiments, a test device may be implemented as a device, separate from other components, that may be connected by the customer to one or more conductors (e.g., wiring, cables, etc.) within the customer's structure. However, the techniques and devices described herein are not limited in this respect. For example, in some embodiments, a test device may be installed in an interface between the external conductors of the service provider network and the conductors inside the customer's premises. As another example, a test device may be configured to reside within another device in the customer's premises, such as a set-top-box (STB) or modem, for example. An embodiment in which a test device may be implemented as a device separate from other components will be discussed with respect to FIG. 1.

FIG. 1 schematically illustrates an example of a customer premises, which in this example is building 2 which may be a residence or other structure. The customer premises is provided with one or more service(s), such as telephone service and/or DSL (Digital Subscriber Line, which comes in multiple forms, such as ADSL and VDSL) service by service provider network 6 via one or more external conductors 3 (e.g., electrical conductors, such as telephone, wiring, in this example). External conductors 3 may be any suitable types of conductors, such as wires, cables, etc., and may be formed of any suitable electrically conductive material (e.g., copper). In the example of FIG. 1, in which telephone service may be provided via external conductors 3, the external conductors 3 may be a twisted pair cable, such as a Tip-Ring pair. External conductors 3 may be connected to the internal conductors 5 (e.g., electrical conductors, such as telephone, wiring, in this example) of the customer premises at an interface 4. Although interface 4 is illustrated in FIG. 1 as being located on the exterior of the customer premises, in some embodiments, an interface between the internal conductors 5 and external conductors 3 may be located on the inside of the customer premises, or in any other suitable location. Interface 4 is an example of a network demarcation point, which in this example is connected between the internal conductors 5 and external conductors 3 of a building 2. However, it should be appreciated that other types of buildings, such as multi-dwelling premises, may have interfaces located at different network demarcation points within and/or outside of the premises.

Internal conductors 5 may be any suitable types of conductors such as wires, cables, etc., and may be formed of any suitable electrically conductive material (e.g., copper). As with the external conductors 3, the internal conductors 5 in this example may be a twisted pair cable, such as a Tip-Ring pair. In this example, interface 4 between the internal conductors 5 and the external conductors 3 may be a Network Interface Device (NID), as known in the art.

The internal conductors 5 may include unfiltered extensions 5-1, 5-3, 5-4 and 5-5, and a filtered extension 5-2. Filtered extension 5-2 has an associated filter 14, which may be a low-pass filter, commonly referred to as a microfilter, to filter out high frequency DSL tones, as known in the art. A telephone 16 may be connected to the filtered extension 5-2. Additional devices may be connected to the unfiltered extensions. For example, as illustrated in FIG. 1, a set top box (STB) 18 may be connected to unfiltered extension 5-3 and a fax machine 20 may be connected to unfiltered extension 5-4. One or more un-terminated extensions 5-5 may also be present, which may give rise to bridged taps as described below.

In some embodiments, a test device 8 may be connected to the internal conductors 5 of the customer premises (e.g., the unfiltered extension 5-1 illustrated in FIG. 1). In the embodiment shown in FIG. 1, a modem 10 is connected to the internal conductors 5 via the test device 8. One or more computing device(s) 12a, 12b, 12c, etc. may be connected to the modem 10 via a wired or wireless connection, either directly or indirectly through another device, such as a router 13. Any suitable type of wired or wireless communication may be used, such as WiFi or Bluetooth for wireless communication, for example, or Ethernet, USB, FireWire, etc., for wired communication, by way of example and not limitation. Examples of computing devices 12a, 12b, 12c include a personal computer (e.g., a desktop or laptop computer), a tablet computer and a cellular telephone (e.g., a smartphone), by way of illustration. However, any suitable type computing device(s) may be used. Router 13 may be any suitable wired and/or wireless router. Router 13 may enable communication between computing device(s) 12a, 12b, 12c and modem 10, thereby forming a local network (e.g., a home network). Any suitable number of computing devices may be present in the home network.

Moreover, it should be appreciated that the devices and connections illustrated in FIG. 1 are exemplary rather than limiting. For example, though FIG. 1 illustrates multiple computing devices connected in a local network, any other network-enabled devices, such as smart appliances, televisions, gaming devices or Internet radios, may be connected to the network. As another example, a set top box may be connected to the local network. Further, though FIG. 1 illustrates that fax machine 20 is not coupled to other device through a filter like filter 14, in some embodiments, such a filter may be used. Moreover, in some scenarios, absence of such a filter may allow a device, such as fax machine 20, to generate signals that can interfere with operation of modem 10 when the device is active. Such a service-affecting condition may be detected by a test device.

In operation, modem 10 may communicate with the service provider network 6 via the internal conductors 5 and external conductors 3. In some embodiments, the modem 10 may be a customer's DSL modem (commonly referred to as ATU-R) that receives DSL service over conductors 3, 5 (e.g., telephone lines). If the service provider network 6 is a telephone network that provides DSL service, the service provider network 6 may include a central office (CO), a toll office (TO), a remote terminal (RT) and/or any other network nodes (not shown), as is known. Such a node may house the main telephone switching equipment for the customer premises and can serve as the location for the DSL service provider's modem (commonly referred to as ATU-C). The TO and the RT may be connected by one or more pairs of wires, and the CO may be connected to the TO via a fiber-optic link. However, the techniques described herein are not limited as to the manner in which signals are transmitted through the service provider network 6.

When modem 10 is a DSL modem, modem 10 may communicate with the service provider's modem using tones of higher frequency than the frequencies typically used for voice communication. In such embodiments, any suitable type of DSL communication may be used. The principles of DSL communication are known in the art and therefore will not be detailed herein. However, briefly, a DSL line may carry both a telephone signal and a data signal. These signals may be communicated at different frequencies and in different formats so that they can be separately processed. The data signal may be formatted as multiple sub-signals, or tones. Each of the tones may be modulated to convey one or more bits of information in a particular interval. The number of a bits that can be conveyed per tone, and the number of tones used, may depend on the characteristics of, or other conditions affecting, conductors used to carry that signal and these parameters of communication may be determined dynamically based on detected conditions. As known in the art, the service provider's modem may exchange data with the customer's modem 10 to provide network access to the customer. This network access may allow for any suitable service (e.g., Internet access).

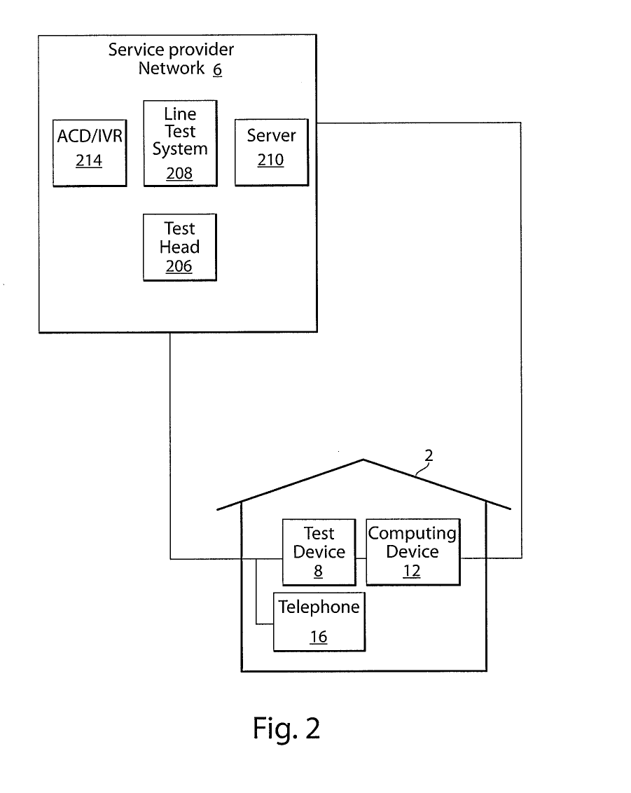

FIG. 2 shows a diagram of a system in which the test device 8 may communicate with one or more other devices to provide additional functionality to aid in testing or troubleshooting. For example, as illustrated in FIG. 2, the test device 8 may communicate with a computing device 12 (e.g., device 12a, 12b and/or 12c, etc.) in the customer's structure. Since, in some embodiments, test device 8 may be a relatively simple device, the customer's computing device 12 may facilitate providing information to the customer regarding a test result obtained using the test device 8. For example, once a test has been performed, the test device 8 may send a test result to the computing device 12. The computing device 12 may use the test result to provide the customer with information regarding the condition identified by the code. Advantageously, the computing device 12 may provide troubleshooting information to assist the customer in resolving the problem. Examples of such techniques will be discussed in further detail with reference to FIGS. 4a and 4b.

In some embodiments, the test device 8 may communicate with the service provider network 6 to exchange test data and/or control commands. For example, the test device 8 may be configured to receive a command from the service provider network 6 to initiate a test. Such a technique may be used in a variety of scenarios. For example, if a customer is having a problem with their service or would like to determine whether the wiring already within the customer's premises can support higher speed data services, the customer may call the service provider (e.g., using telephone 16 or a cellular telephone). The customer's call may be handled by an Automated Call Distribution/Interactive Voice Response System (ACD/IVR) 214. ACD/IVR system 214 may be implemented using techniques as are known in the art. Though, it may be programmed to interact with test device 8 at a customer's premises.

To assist in resolving a problem or pre-qualifying wiring at a customer's premises for higher speed data services, the ACD/IVR system 214 may interact with test device 8. In a scenario in which a customer has called ACD/IVR system 214 using a telephone on the customer premises, there may already be a connection, using the telephone service such that the interaction may occur over a telephone line. In some embodiments, that interaction may be performed using signaling tones designated for communications between the test device 8 and a remote computing device.

That interaction may include sending a command to the test device 8 to cause test device 8 to provide test results. The command may initiate an electrical test on the conductors of the customer premises and/or may trigger test device 8 to provide results of a most recently performed test.

This information may be used by the ACD/IVR system 214 in any suitable way. For example, the information may be used as part of an automated diagnosis technique. Test results from test device 8, reflecting a condition of conductors in a customer's premises, for example, may be used to localize a service-affecting condition to either the service provider's network or the customer's premises. The test results also may be used to rule in or rule out problems, either in the premises or within the service provider network. The test results also may be used to confirm a diagnosis or increase the confidence in a conclusion as to the source or location of a condition affecting service.

Alternatively or additionally, the test results may be used by ACD/IVR system 214 to direct the service flow. For example, ACD/IVR system 214 may be programmed to prompt a customer for more information when test results from a test device within a customer's premises are not available than when results are available. As a specific example, if a quiet line noise measurement is available from test device 8, ACD/IVR system 214 may be programmed to omit questions prompting a customer to provide information about problem symptoms that might reveal a noise source creating interference with digital data services, but to ask those questions otherwise. As yet another example, if test device 8 is programmed to test for missing microfilters within the customer's premises, and if the test results indicate that missing microfilters were detected, ACD/IVR system 214 may present to the customer instructions for obtaining and installing microfilters.

As yet a further use of such data, it may be used to condition access to a human service representative or to otherwise prioritize service provided to a customer. Because of the high cost to a service provider of making a human service representative available to a customer, a service provider may prioritize such access to those customers most likely to be experiencing problems with the service provider's network, and not problems within their own premises. Alternatively or additionally, including a step in a service flow that requires or encourages customers to conduct a test with a test device on their premises promotes diagnosis by a human customer service representative that has better information on which to diagnose a customer's problem. Having test results passed to ACD/IVR system 214 or other suitable computing device that is part of the service provider's network may provide the customer service representative with additional information, not available by asking questions of the customer. Moreover, in some scenarios, information provided by a test device may be more reliable than comparable information provided by a customer. A customer, for example, may inadvertently provide incorrect information or may make up information, thinking that doing so will expedite the service process.

As yet a further use of data from test device 8, ACD/IVR system 214 may use that data to provide the customer with information regarding a test result (e.g., a test result code) and/or troubleshooting information to aid the customer in resolving the problem. Such information may be provided to the user in a variety of ways, such as through automated speech generated by ACD/IVR system 214. As another example, information may be communicated in digital form for display on the test device 8, such as in the form of a test result code. In another example, a customer's computing device 12 may receive the test result and/or additional information from the server 210 or another computing device within the service provider network 6, for presentation to the customer. Though, it should be appreciated that any suitable device may be used to output such information. For example, in a scenario in which the test device is embedded within a set top box (18, FIG. 1), or otherwise connected to a television, the information may be presented as text, graphics or audio-video information on the television or another display device separate from a computing device.

It should be appreciated that, though ACD/IVR system 214 provides one mechanism by which test device 8 may interact with a component in the service provider's network, other modes of interaction may alternatively or additionally be supported. In another exemplary scenario, when a service problem occurs, the customer may go online to obtain assistance from the service provider via the Internet. For example, the customer may visit the service provider's web site using a web browser or may use an application program (i.e., an “app” for a smart phone, tablet P.C., or other device) that enables the customer to exchange information with the service provider over the Internet. To do so, the customer may use computing device 12 to communicate with a server 210 of the service provider network 6. As an example, if the customer is having a problem with their service that prevents access to the Internet through the service provider (e.g., DSL service), the customer may access the Internet using another medium, such as a cellular data connection, for example. The customer may thereby communicate with the service provider network 6 (e.g., via server 210) to request assistance. In one example, the service provider may provide assistance through the exchange of messages (e.g., using a chat session), or using any other suitable technique. In the course of providing assistance to the customer, the service provider network 6 may exchange information with the test device 8. As in other embodiments, the information exchanged may include a command to control operation of the test device and/or test data, as discussed above.

In some embodiments, interaction between the test device 8 and the service provider network may entail exchange of information for the purpose of detecting or localizing service-affecting conditions within the service provider network and/or within the customer's premises. In such a scenario, the “information” exchanged may serve as test signals that may be generated or measured at either test device 8 or a computerized device within the service provider network. Such testing may allow for double-ended measurements, such as may be used to detect shorts or opens or to determine attenuation at various frequencies or other parameters of a line.

Based on the measurement of such parameters, multiple conditions might be detected. For example, from a frequency profile, service-affecting conditions such as degraded insulation, wet wiring, or bridged taps might be detected. The measurements may also be used to identify configuration problems. For example, failure to detect a DSL tone that should be on a line may indicate a component, such as a modem intended to be present to generate such a signal, is not present. Though, it is not a requirement that interactive testing in this mode be based on measured parameters of a line. For example, a test device may contain circuitry on its line interface to present an impedance signature characterizing the device as a test device. An interactive measurement may test to determine whether such a signal can be detected, which may indicate end-to-end connectivity and may also generate information about the presence and/or capabilities of the test device, which may be useful in analyzing in data purportedly from the test device.

Accordingly, if the service provider has capabilities to perform another type of test, such as a test using line test system 208, that test may be adapted to include a mode in which there is interaction with a test device within a customer's premises. Such a test may be initiated as part of a test sequence when a test is performed by test device 8, or at any other suitable time when a test is desired to be performed on the external conductors 3 leading to the customer premises. For example, as described above, a customer call may be handled in accordance with a test flow that involves a series of interactions with the service provider. Those interactions may initially be performed with an automated system such as ACD/IVR system 214, initially based on readily available information or customer input. If the automated call processing does not resolve the customer's concern, the call may be transferred to a human customer service representative.

That human customer service representative may receive data collected by ACD/IVR system 214 when the call is transferred. That data may include data collected from test device 8. The human customer service representative may use that data to determine whether use of the line test system is warranted. If so, that test may involve interaction between the line-test system and the on-premises test device 8. Though, it is not a requirement that such a test involving interaction be initiated by a human customer service representative.

Regardless of how such a test is initiated, when a test is initiated, the line test system 208 may control the test head 206 to send a signal to the test device 8 via any suitable communication channel, including the external conductors 3 and internal conductors 5. Such a signal, or signals, may serve any one or more purposes useful in determining whether a service-affecting condition exists of localizing the service-affecting condition, In some embodiments, test head 206 may simply measure properties of the signal to determine whether a signature of test device is detected, which can determine that a communication path is present.

In other scenarios, the test device 8 may make a measurement of the signal received from test head 206. Such a test may be used to measure a loss of signal between the test head 206 and the test device 8, and/or any other suitable electrical parameter, such as a fault. Alternatively or additionally, the test head 206 may transmit a broadband stimulus signal for detecting service-affecting conditions within the customer premises, as described below. The result of the test may be analyzed by test device 8 and/or the line test system 208. For example, the test device 8 may send a measurement and/or test result to the service provider network 6 for further analysis.

Alternatively or additionally, test device 8 may generate a signal that can be measured by test head 206. In a similar vein, measurement of parameters of the test signal may be used to determine characteristics of the conductors between test device 8 and test head 206. Though, any suitable type of signal may be generated directly or indirectly and interactive measurement may be made directly or indirectly. As an example of indirect signal generation, test head 206 may trigger a modem or other component to transmit a DSL signal, or a test signal representing one or more aspects of such a signal. As an example of indirect signal measurement, test head 206 may receive an indication from a modem or other component that a DSL signal, or a test signal representing one or more aspects of such a signal, was received. Such indirect measurements may confirm both conditions of the conductors that carry such signals but may also serve to confirm that the components, such as modems, used for indirect signal generation or measurement are present and operating correctly.

Although, in some embodiments, a test may be initiated in response to a customer's request for assistance, the techniques described herein are not limited in this respect. In some embodiments, the service provider may take action proactively to perform one or more tests. For example, a test may be initiated by the service provider in response to detecting a decrease in performance of a connection as indicated by data generated by a customer's modem 10 or other modem. These parameters may indicate, for example, that the dynamically selected parameters of a communication protocol, such as DSL, do not support bandwidth above a predetermined threshold or fail to meet some other criteria. As another example, the service provider may initiate tests periodically, if desired. Such techniques may allow the service provider to detect a problem before the customer notices the problem or requests assistance. If the service provider detects a problem in this manner, the service provider may notify the customer through any suitable medium (e.g., telephone call, e-mail or text message). For example, the service provider may send a notification to the customer of the nature of the problem and/or a suggested action to be taken. For example, the customer may be requested to access the service provider's web site to obtain additional information regarding the problem detected or to use an application program suitable for obtaining assistance from the service provider.

Having described a system and various scenarios in which a test device 8 may be used to perform measurements on internal conductors 5 of a customer's structure, an example of a test device 8 will be described.

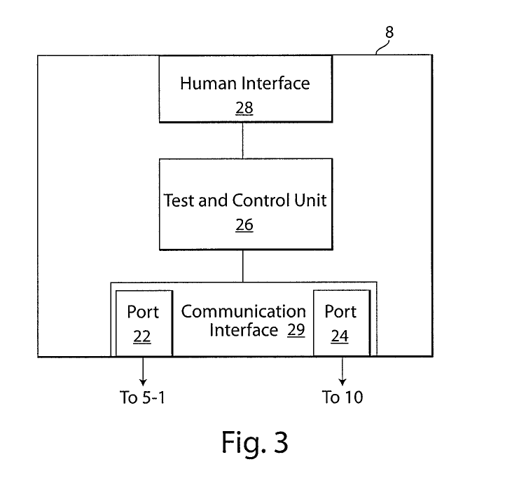

FIG. 3 shows a block diagram of a test device 8, according to some embodiments. As discussed above, in some embodiments the test device 8 may be relatively simple device that may be located on the customer premises configured to test an electrical conductor within and/or outside of the customer premises. Though, test device 8 may be configured to perform other test functions, including interacting with a computerized device operated by a communication service provider.

The test device 8 may have a communication interface 29 for making a test connection to the internal conductors 5 and/or for communicating with one or more other devices. For example, the communication interface may have a port 22 configured to be connected to the internal conductors 5. Port 22 can be configured to be connected to any suitable type of wires, cables, or other type of internal conductors 5. In an embodiment as illustrated in FIG. 1, the test device 8 may also have a port 24 for connecting to another device, such as modem 10, through another conductor (e.g., wire, cable, etc.). Port 22 may be a connector of the type used for connecting devices used for the communication service to internal conductors 5. For example, if the test device 8 is configured to test DSL service, ports 22 and/or 24 may include a connector configured to connect to telephone wiring (e.g., an xDSL-compatible connector such as an RJ 11 socket or plug). However, the test device 8 may be configured to connect to any suitable type of conductors. For example, in some embodiments, test device 8 may be configured to test cables carrying cable television and/or cable Internet services. In such cases, ports 22 and/or 24 may be configured to connect to a coaxial cable. The techniques described herein are not limited as to the type of conductors tested by test device 8.

The test device 8 may include a test and control unit 26 connected to the communication interface 29. In operation, test and control unit 26 may control the test device 8 to perform one or more tests on the internal conductors 5. For example, the test and control unit 26 may perform electrical tests to detect a fault or service-affecting condition that may be present on the internal conductors 5 and/or the external conductors 3 leading to the customer premises. In some embodiments, the test and control unit 26 may be configured to perform spectral analysis of signals of different frequencies measured on the internal conductors 5. The test and control unit 26 may analyze the measured frequency spectra to identify the cause of a service problem. Any of a variety of suitable tests may be performed, examples of which are discussed herein.

In some embodiments, the test device 8 may include a user interface 28 configured to receive inputs from a user and/or to provide information to the user. For example, in some embodiments the user interface 28 may include one or more input devices to receive input from a user. Though, in some embodiments, test device 8 may not have a user interface. Rather, through communication with another device that includes a user interface, test device 8 may receive user inputs and may output information to a user.

In some embodiments in which test device 8 has a user interface, this interface may have a simple design. As an example of an input device, a button may be disposed on the test device 8, which, when pressed by the user, initiates performing a test or sequence of tests by the test and control unit 26. Any suitable input devices may be included in user interface 28, such as a button, switch, touch-screen, keyboard, etc. In some embodiments, the user interface 28 may be configured to provide information to a user in a human perceptible format, such as a visual format. For example, the user interface 28 may include a status light (e.g., an LED) to display the status of the test device 8. As another example, the user interface 28 may include a display to display a test result, such as a test result code. For example, the user interface 28 may include a seven-segment alphanumeric display (e.g., a single-character display or multiple-character display) to display a code representing a test result, in some embodiments. As yet another example, the user interface 28 may include a display screen (e.g., an LCD screen) that displays information, such as the status of the device, a test result, corrective actions to be taken, troubleshooting information, etc.

In some embodiments, when a test result code is displayed by the test device 8, the user may view the displayed code and associate the code with a corresponding condition of the conductors. For example, the customer may be provided with printed or electronic reference material, which may be software or a link to a web site where the reference material can be accessed, that allows the user to look up the code to find out additional information regarding the determined condition. For example, the customer may be provided with information to enable the customer to troubleshoot and potentially resolve a problem, as discussed further below.

In embodiments in which the test device is used as part of a method to pre-qualify a line for a high speed data service, the output produced by the test device may indicate a pre-qualification state of the customer's premises wiring. The output may indicate, for example, that the wiring is qualified or not qualified for a desired high speed data service, such as VDSL2. Alternatively or additionally, the output may indicate that the wiring could be qualified for high speed data services if one or more extensions were appropriately terminated. In some scenarios, an appropriate termination might be achieved by plugging into an extension a suitable modern telephone or other device that provides an appropriate termination such that signals that could interfere with high speed data services are not reflected from the extension.

In some embodiments, the communication interface 29 may enable the test device to communicate with one or more external computing devices, which may be internal to the customer's premises our outside the customer premises. Examples of such computing devices include computing device 12 or a computing device of the service provider network 6, for example. Any suitable type of communication interface 29 may be used to communicate with other devices, such a wired communication interface and/or a wireless communication interface, for example. In some embodiments, the communication interface 29 may enable the test device 8 to receive a command, such as command for initiating a particular test or a test sequence.

The communication interface 29 may enable the test device 8 to send information, such as a test result code, to another device. As discussed above, in some embodiments, a test result may be sent to the service provider network 6 to enable the service provider to receive the test result. The service provider may analyze the test result and send information to the customer, such as troubleshooting information, corrective action to be taken, etc. The service provider may store the test result in a database of test results for future analysis, in some embodiments.

Alternatively or additionally, the service provider may use information from test device 8 to offer a high speed data service to a customer or as part of an installation process for that high speed data service, The service provider, for example, may use the information from a test device to determine whether a modem, and/or other equipment used in providing high speed data service, may be sent directly to a customer for self-installation or whether a technician will be dispatched to install the high speed data services at the customer's premises. A technician may be dispatched, for example, when the test results indicate that the changes to the customer's premises wiring will be made as part of the installation process.

If the information regarding the test result is sent to computing device 12 (either directly or via the service provider network 6), computing device 12 may display a test result, and/or may interpret the test result to provide additional information to the user, such as troubleshooting information, corrective action to be taken, etc. Moreover, by enabling communication between an external computing device and a test device that can be simply connected to internal conductors within a customer's premises, the external computing device may drive a test sequence.

The customer may participate in that test sequence in one or more ways. That participation may include connecting the test device to at one or more locations within the premises or observing conditions at the premises. The customer may input information about the observed conditions through a user interface on computing device 12 such that the customer observations may be used as part of troubleshooting. For example, the user may be asked to confirm the presence of microfilters or to indicate a state of status indicators of equipment, such as a modem.

Customer participation may alternatively or additionally include establishing conditions at the customer premises, such as taking a phone off hook or connecting the test device at a particular location. Establishing the conditions alternatively or additionally may include altering conditions at the customer premises. For example, when measurements indicate that a low frequency interference is present and a possible source of a problem reported by a customer, the customer may be guided through steps of moving electronic devices with large power supplies that could generate such interference from locations where those devices could cause noise that is a possible source of a problem experienced by a customer.

In embodiments in which the test device is used to pre-qualify customer premises wiring for high-speed data services, customer participation may entail terminating extensions. Analysis, as described below, of measurements by the test device may reveal one or more bridged taps within the customer premises. The analysis may reveal whether these bridged taps are of a length, or have other characteristics, that create a service-affecting condition. In a customer premises, such bridged taps may be the result of an un-terminated extension. Accordingly, if analysis of a measured signal suggests that a bridged tap is or would create a service-affecting condition, the customer may be instructed to attempt to reduce the effect of the bridged tap by terminating extensions. The customer, for example, may be instructed to terminate an unused extension. Such a termination may be achieved with any suitable device, which may be a good quality modern telephone or a device having impedance characteristics matched to a telephone line so as to avoid reflections.

The customer also may input information that controls progression through the test sequence, For example, the user input may indicate that directed conditions have been established. In response, the computing device may request the test device to repeat the same series of measurements or to perform different tests. In some simple embodiments of test device 8, test device 8 may be configured to perform the same series of measurements and output the same types of information each time a test is requested. Though, other embodiments are possible in which a test device may accept multiple commands that initiate different types of tests or that trigger the device to output different types of data.

In some embodiments, customer input that controls progression through the test sequence may be input through a user interface of a computing device interacting with test device 8. Though, such information, and any other information, alternatively or additionally may be input through test device 8. For controlling the progression through a test sequence, for example, the customer may press a button on test device 8 that triggers device 8 to perform a test.

Checking if Customer's Installation Will Support High Speed Data Services

The service-affecting conditions detected by a system as described herein may relate to a current service. Though, in some embodiments, conditions may relate to a desired or future service to be delivered over conductors 5 within a premises. In some embodiments, test device 8 may perform a test to determine whether the customer's wiring environment will support a high speed data service, such as VDSL2. VDSL2, for example, may operate at frequencies up to 30 MHz, such that

Such a test may be requested either by the customer or a service provider and may be performed to determine whether the premises wiring will support the high speed data services. In some embodiments, when requested by the service provider, any suitable communications mechanisms between a service provider and a test device, including those as described above, may be used. Likewise, when requested by the customer, any suitable communications mechanisms between a customer and a test device, including those as described above, may be used. Whether or not requested by a service provider or a customer, the customer may participate in the testing by adjusting conditions at the customer premises. Though, such adjustments alternatively or additionally may be made by a technician dispatched by the service provider.

The determination of whether premises wiring support high-speed data services may be made prior to installation of the equipment used in supplying that high speed data service. For example, the test may be performed before a high speed modem is installed at the customer premises or the customer's premises are connected to a modem in a central office of the service provider's network. Moreover, the pre-qualification may be performed prior to the service provider dispatching a technician to the premises to test or reconfigure the premises wiring to support the high speed service.

Alternatively or additionally, when the prequalification testing determines that the customer premises can support high-speed data services without modification, the service provider may provide the services without dispatching a technician at all. The service provider, for example, may ship a high-speed data and other equipment used in providing high-speed data services directly to the customer for self-installation. Even in scenarios when the testing determines that the premises wiring can support high-speed data services with modifications that can be readily made by the customer, the service provider may ship the equipment for self-installation. Though, in this scenario, the customer may be provided with instructions for making the modifications, such as by providing the customer with instructions to terminate an extension. These instructions may be provided in any suitable way, such as by the service provider through an IVRS, through the test device or through a computing device coupled to the test device or other computing device operated by the service provider.

Regardless of how results of the test are used, to make a determination of whether premises wiring can support high-speed data services, spectral measurements may be made at a higher frequency than would have been necessary for a slower-speed service. For example, spectral measurements may be made up to a frequency of 30 MHz to determine spectral characteristics of the wiring environment at such frequencies, whereas tests at up to 2 MHz may be sufficient to troubleshoot the user's current installation. Accordingly, test device 8 may be configured to perform such spectral measurements. For example, the test device 8 may be configured to perform spectral measurements, such as one or more QLN measurements, in a frequency range spanning from 0 to 30 MHz. However, it should be appreciated that tests performed in any suitable frequency range may be performed. For example, to test the viability of future high-speed upgrades, tests may be performed in a range extending up to 28 MHz, 50 MHz, 100 MHz, or higher. The range may begin at any suitable frequency, such as 0 Hz, 10 kHz, or 1 MHz, or 2 MHz by way of example.

FIGS. 4A, 4B and 4C illustrates how measurements may be used to determine whether there is a service-affecting condition that may impact the suitability of the customer premises wiring or a high-speed data service. In this example, the service-affecting condition is a bridged tap. As is known in the art, a bridged tap results from an un-terminated or improperly terminated wire that is not used to carry a signal extending from another wire is used to carry the signal. The bridged tap impacts performance because a signal traveling along the wire carrying the signal may propagate down the bridged tap and be reflected from its end. The reflections propagate back to the wire carrying the signal and interfere with the signal on that wire.

Within a customer premises, a bridged tap may result from an un-terminated or improperly terminated wire run to support a telephone extension. The effect of a bridged tap is frequency dependent such that a bridged tap may have a greater impact on high-speed data services than conventional telephone service or even lower speed data services, such as ADSL.

FIG. 4A illustrates a possible stimulus signal that may be applied to a telephone line for testing as described herein. The singular FIG. 4A is illustrated in the frequency domain and corresponds to a signal that may be generated in the L0 state of an ADSL modem. In the L0 state, the modem transmits all tones ported by the modem in equal magnitude. Accordingly, FIG. 4A illustrates a spectrum across a frequency band corresponding to the frequency band used for the high-speed data services. In an embodiment in which testing is performed for VDSL2 services, the spectrum may span a band up to about 30 MHz and the lower limit of the band may be approximately 1 MHz.

Though, it should be appreciated that FIG. 4A illustrates only one possible example of a stimulus signal that may be used for testing as described herein. It is not a requirement that the stimulus signal have the same spectrum as is used to provide high-speed data services for which testing is to be performed. Moreover, it is not a requirement that the stimulus signal have frequency components that are uniform across a frequency band as illustrated in FIG. 4A.

In some embodiments, a stimulus signal as illustrated in FIG. 4A may be generated by a modem, such as modem 10 (FIG. 1), installed at a customer premises. Though, to support prequalification, in which a modem that supports high-speed data services is not installed at the customer premises, the stimulus signal may be supplied by a modem or other device within a service provider network 6 (FIG. 1).

Regardless of the source of the stimulus signal, a response may be measured at the customer premises, such as by a test device 8 (FIG. 1). FIG. 4B illustrates a spectrum of a response signal measured at the customer premises in a scenario in which no service-affecting condition is present at the premises. In this example, the spectrum of the response signal spans approximately the same frequency range as the stimulus signal. However, the amplitude of each frequency component has been attenuated by transmission over the wiring between the external source of the stimulus signal and the test device making the measurement. In the example shown in FIG. 4B, the attenuation is frequency dependent such that greater attenuation occurs at higher frequencies.

In this example, the attenuation is shown to generally increase linearly with respect to frequency. A test device may analyze a measured response signal and classify it, based at least in part on this linear response, as having characteristics associated with a scenario in which no service-affecting edition is present. Though, it should be appreciated that FIG. 4B is an idealized representation of a response signal. A response signal indicative of a scenario in which no service-affecting condition is present may have any suitable characteristics. Regardless of those characteristics, a device analyzing a measured signal may be programmed to recognize when they are present. Accordingly, a test device, or other suitable device analyzing a measured signal, may determine that no service-affecting condition is present.

Conversely, FIG. 4C illustrates a response signal when a service-affecting condition is present within the premises wiring. In this example, the service-affecting condition is a bridged tap. As can be seen from a comparison of FIG. 4B and FIG. 4C, the spectrum of the response signal, though it decreases generally linearly, is modulated with a low frequency component. In the specific example of FIG. 4C that low-frequency component is seen as approximately 1½ cycles of a periodic waveform modulating the frequency spectrum. The inventors have recognized and appreciated that modulation of the frequency response with a low frequency component is indicative of a service-affecting condition such as a bridged tap.

Accordingly, a test device, or other suitable device analyzing a measured signal, may be configured to determine whether there is a low frequency variation of the frequency spectrum of the response signal. The precise range of frequencies corresponding to a “low-frequency” variation may depend on the operating frequency range of the high-speed data services for which prequalification is being performed. However, in some embodiments, the upper limit of frequencies considered to be low may be signals with a period of approximately 1/30^{th} of the bandwidth of the stimulus signal and/or the bandwidth used for high-speed data services and/or the maximum frequency used for the high-speed data services. Though, in other embodiments, the relevant fraction may be 1/20^{th}, 1/10^{th}, ⅕^{th}, or any other suitable value.

Regardless of the specific fraction, or other mechanism by which a low-frequency signal is defined, that variation may be identified in any suitable way. In some embodiments, the low-frequency variation of a frequency spectrum may be determined by digital signal processing implementing a low pass function performed on measured coefficients of a frequency spectrum. Such processing may be performed in a digital signal processor, a conventional processor programmed to perform that function, using analog circuitry or in any other suitable way.

Regards of the manner in which the low-frequency variation is identified, the magnitude and period of that low-frequency variation may provide an indication of whether a service-affecting condition is present. The period of the low-frequency variation, for example, may be related to frequencies at which a bridged tap will interfere with signals. If disrupting communications on the premises wiring at those frequencies would interfere with the high-speed data services, which may be determined from such factors as the frequency spectrum and error correction capabilities of the high-speed data services, the premises wiring may be deemed unsuitable for high-speed data services. Likewise, if the magnitude of the low-frequency variations are relatively large, the premises wiring also may be deemed unsuitable for high-speed data services. Though, depending on the characteristics of the measured low-frequency variations, it may be determined that simple changes to the premises wiring, such as appropriately terminating a bridged tap, may remove the service-affecting condition.

FIGS. 4A-4C illustrate a scenario in which a device, such as a modem, is available to generate a stimulus signal that will reach a customer premises. The inventors have recognized and appreciated, however, that an express stimulus signal is not required to perform analysis according to techniques as described herein. In some embodiments, noise otherwise present on the line may act as a broadband stimulus signal such that an analysis of low-frequency variations in a noise spectrum may reveal the same information that might be derived from a response to a stimulus signal, as described above. Using noise measurements, without a stimulus signal, may enable application of test techniques as described herein in customer premises that are not configured for high-speed data services. As a result, the test techniques described herein may be used for prequalification, even in scenarios in which a premises is not connected to any modem or other device capable of generating signals as used for high-speed data services

FIG. 5A illustrates an approach for using noise measurements to determine whether customer premises have a service-affecting condition that might impact suitability of the premises wiring for high-speed data services. FIG. 5A illustrates a measured curve 510, measured in response to a stimulus signal, such as the L0 pulse illustrated in FIG. 4A. FIG. 5A illustrates a measured curve 550, measuring noise at the customer premises.

As can be seen by a comparison of the curve 510 and the curve 550, both curves are modulated with similar low-frequency components. For example, curve 510 has local maxima at points 512 and 516. Curve 550 has local maxima, as illustrated by points 552 and 556, in corresponding locations. Curve 510 has local minima at points 514 and 518. Curve 550 has corresponding local minima at points 554 and 558. Accordingly, by analyzing low-frequency variations of the frequency spectrum of the measured noise signal, information about a service-affecting condition may be derived using techniques as described above.

FIG. 5B illustrates a measured signal in a different scale. The low-frequency variations are difficult to see in the scale shown in FIG. 5B. However, in some embodiments, a test device may have sufficient sensitivity (e.g., a noise floor at or below −142 dBm/Hz) for low-frequency variations to be detected. Measurements made with such a device may be transformed into the frequency domain using any suitable transformation technique. The transform coefficients may then be analyzed to detect low-frequency variations as described above. The low-frequency variations, for example, may be determined by detecting local maxima and minima as illustrated in FIG. 5A. The difference between the maxima and minima, in both amplitude and frequency, may be correlated, such as through empirical measurements or modeling of a line, to characteristics corresponding to a service-affecting condition.

Though examples are provided herein in which a comparison is made deterministically, should be appreciated that is not a requirement of the invention that there be a deterministic relationship between measured low-frequency components and a classification of customer premises wiring as a suitable or unsuitable for high speed data services. In some embodiments, the correlation between measured low-frequency characteristics and a classification indicating the suitability of the premises wiring for high-speed data services may be probabilistic. Such a probabilistic computation may be based on trained classifiers, neural networks or other suitable approaches for computing a likelihood or other indication that a set of measured values corresponds to specific state. In this example, those states may correspond to qualified for high-speed data services, not qualified for high-speed data services, each containing a service-affecting condition that can be remedied by terminating an extension or other suitable prequalification state.

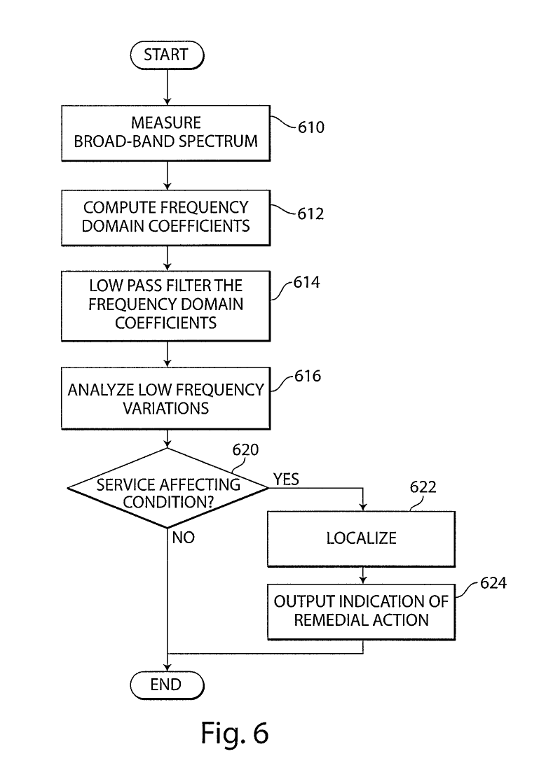

Regardless of the manner in which the low-frequency components of the measured frequency spectrum are analyzed, FIG. 6 illustrates a manner in which such a technique may be used as part of a method for prequalifying premises wiring for high-speed data services. The method of FIG. 6 may be performed using any suitable hardware. In some embodiments, the entire method may be performed within a test device installed at a customer premises. In other embodiments, all or a portion of the processing illustrated in FIG. 6 may be performed in a computing device coupled to the test device. The computing device may be a customer computing device or may be provided by a service provider. If provided by the service provider, the computing device may be coupled to the test device through the service provider's network, may be brought to the customer's premises by a technician or may be coupled to the test device in any suitable way.

The method of FIG. 6 begins at block 610. At block 610 a broadband spectrum is measured on telephone wiring within a premises that is to be prequalified for high-speed data services. In the some embodiments, the broadband spectrum may be made while a stimulus signal is being applied to that telephone wiring. However, in the embodiment pictured in FIG. 6, the broadband spectrum is a noise spectrum measured without a specific stimulus signal being applied. The measurement to be made by any suitable device, such as a test device as described above installed at the customer's premises.

The method proceeds to block 612 where frequency domain coefficients are computed from the measured signal. These coefficients may be computed using any suitable frequency domain transformation.

At block 614, a low pass filtering operation may be performed on the frequency domain coefficients. In some embodiments, the low pass filtering operation may be implemented as a digital filter using techniques as are known in the art. Though, it should be appreciated that any suitable technique for deriving information about low-frequency variations in the frequency domain coefficients that represent the spectrum of the measured signal may be used. For example, rather applying a digital filter algorithm to the frequency domain coefficients, the frequency domain coefficients may be analyzed to identify local maxima and minima, as described above in connection with FIG. 5A.

Regardless of the manner in which the low-frequency variations are identified, processing may proceed to block 616. At block 616, the low frequency variations may be analyzed. The analysis may include determining both the magnitude and period of those low-frequency variations to support a comparison to low-frequency variations known to be associated with service-affecting conditions. Any suitable technique for comparison may be used.

Moreover, it should be appreciated that the examples given herein show a single low-frequency component for simplicity of illustration only. In some embodiments, service-affecting conditions within customer premises wiring may generate within a frequency spectrum multiple low-frequency components. Accordingly, analysis at block 616 may entail comparing characteristics of multiple low-frequency components to low-frequency variations known to be associated with service-affecting conditions. Such comparisons may be made in any suitable way.

Regardless of the manner in which the comparisons are made, the method may proceed to decision block 620. At decision block 620, the method may branch, depending whether the comparisons indicate that the measured low-frequency components are associated with low-frequency variations known to be associated with a service-affecting condition. Such determination may be made in the affirmative or in the negative, meaning that the customer premises wiring may be deemed qualified for high-speed data services if the measured low-frequency components match a known suitable profile or, conversely, do not match a profile known to be associated with unsuitable conditions within the premises wiring. Likewise, the customer premises wiring may be deemed not qualified for high-speed data services if the measured low-frequency components match a known unsuitable profile or, conversely, do not match a profile known to be associated with suitable conditions within the premises wiring.

Regardless of the manner in which this determination is made, if the determination indicates that a service-affecting condition is present, processing may branch to block 622. At block 622, optionally, a localization process may be performed. In this scenario, localization may be performed by interaction with a customer. As a specific example, localization may be performed by instructing a customer to attach a modern telephone or other devices with suitable impedance characteristics to terminate an extension into an extension. The test device may then repeat the measurements and analysis at block 610, 612, 614 and 616 to determine whether terminating the extension removed the service-affecting condition. So, the service-affecting condition may be localized to that extension.

Regardless of whether the localization processing is performed at block 622, the method may proceed to block 624 where an output of remedial action may be provided. In this example, that output may indicates that premises wiring may need to be reinstalled to support high-speed data services. Alternatively or additionally such output may indicate that further determination of extensions is required for high-speed data services. As yet another example, the output may indicate the severity of the service-affecting condition, which may be derived based on the amplitude and period of detected low-frequency variations in the measured frequency spectrum or in any other suitable way. Though, it should be appreciated that the output may indicate that any suitable prequalification state determined by analysis using techniques as described herein.

Conversely, when no service-affecting condition is detected, processing may bypass outputting an indication of remedial action at block 624. Though not expressly illustrated in FIG. 6, if no service-affecting condition is detected, a suitable output may be made indicating that prequalification state of the customer premises.

These outputs may be made in any suitable way, including through a user interface to the customer, a technician at the customer premises, or to another computing device, whether operated by the customer, service provider other party.

The techniques as described herein may be implemented in any suitable device. In some embodiments, all or a portion of the processing as described herein may be performed in a computing device. The computing device may be programmed or may be configured in any other suitable way to perform processing as described herein.

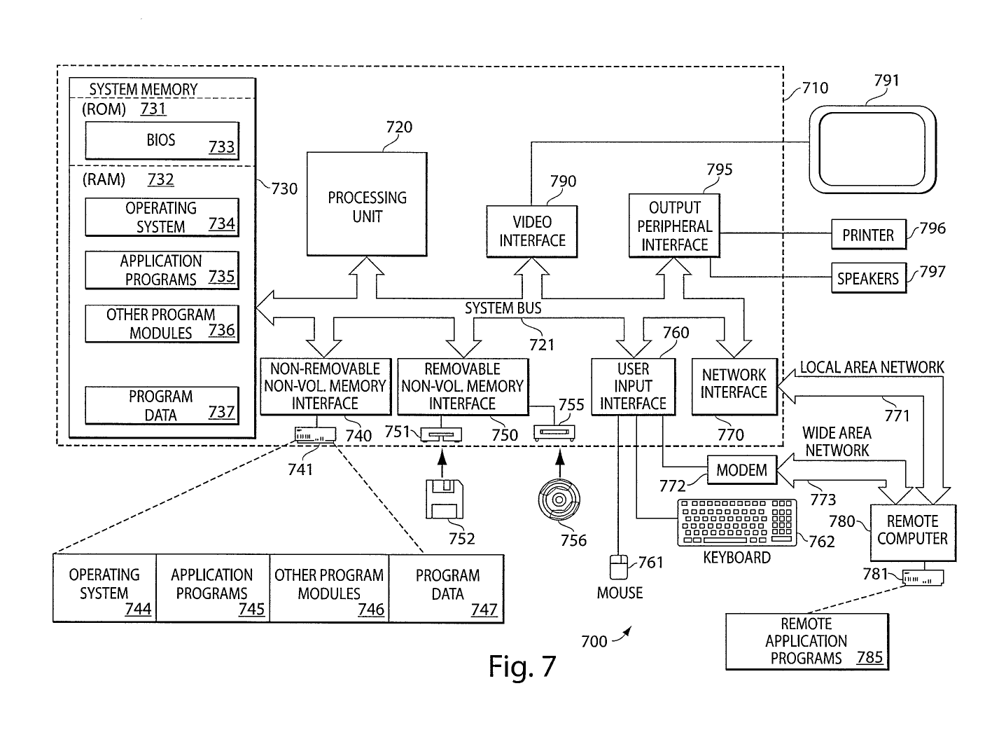

FIG. 7 illustrates an example of a suitable computing system environment 700 on which the invention may be implemented. The computing system environment 700 is only one example of a suitable computing environment and is not intended to suggest any limitation as to the scope of use or functionality of the invention. Neither should the computing environment 700 be interpreted as having any dependency or requirement relating to any one or combination of components illustrated in the exemplary operating environment 700.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 7, an exemplary system for implementing the invention includes a general purpose computing device in the form of a computer 710. Components of computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 710 typically includes a variety of computer readable media. Computer readable media can be any available media that can be accessed by computer 710 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 710. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736, and program data 737.

The computer 710 may also include other removable/non-removable, volatile/nonvolatile computer storage media. By way of example only, FIG. 7 illustrates a hard disk drive 741 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through an non-removable memory interface such as interface 740, and magnetic disk drive 751 and optical disk drive 755 are typically connected to the system bus 721 by a removable memory interface, such as interface 750.

The drives and their associated computer storage media discussed above and illustrated in FIG. 7, provide storage of computer readable instructions, data structures, program modules and other data for the computer 710. In FIG. 7, for example, hard disk drive 741 is illustrated as storing operating system 744, application programs 745, other program modules 746, and program data 747. Note that these components can either be the same as or different from operating system 734, application programs 735, other program modules 736, and program data 737. Operating system 744, application programs 745, other program modules 746, and program data 747 are given different numbers here to illustrate that, at a minimum, they are different copies. A user may enter commands and information into the computer 710 through input devices such as a keyboard 762 and pointing device 761, commonly referred to as a mouse, trackball or touch pad. Other input devices (not shown) may include a microphone, joystick, game pad, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. In addition to the monitor, computers may also include other peripheral output devices such as speakers 797 and printer 796, which may be connected through a output peripheral interface 795.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include a local area network (LAN) 771 and a wide area network (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760, or other appropriate mechanism. In a networked environment, program modules depicted relative to the computer 710, or portions thereof, may be stored in the remote memory storage device. By way of example, and not limitation, FIG. 7 illustrates remote application programs 785 as residing on memory device 781. It will be appreciated that the network connections shown are exemplary and other means of establishing a communications link between the computers may be used.

Additional Aspects

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of identifying a service-affecting condition on a line, the method comprising:
measuring a frequency spectrum on the line, wherein the measurements are un-correlated with a stimulus signal;
with at least one processor, determining whether a low frequency variation exists in the frequency spectrum; and
based, at least in part, on the determination of whether a low frequency variation exists, indicating a state of the line.

2. The method of claim 1, wherein:
indicating a state of the line comprises indicating that the line, without modification, will support a high speed data service.

3. The method of claim 1, wherein:
indicating a state of the line comprises indicating that the line, if an extension is terminated, will support a high speed data service.

4. The method of claim 1, wherein:
indicating a state of the line comprises indicating that the line, if modified, will support a high speed data service.

5. The method of claim 1, wherein:
the frequency spectrum of the line is measured across a frequency range that includes 1 MHz to 28 MHz.

6. The method of claim 5, wherein the low frequency variation has a period, in the frequency domain, of greater than 1/10^{th} of the frequency range of the frequency spectrum.

7. The method of claim 1, wherein:
indicating the state of the line further comprises determining, based, at least in part, on the magnitude of a frequency component of the low frequency variation, a severity of a service-affecting condition on the line.

8. The method of claim 1, wherein the measured frequency spectrum is a noise spectrum.

9. The method of claim 1, wherein the line is premises wiring for telephone services.

10. The method of claim 9, wherein:
indicating the state of the line comprises indicating a pre-qualification state for VDSL2 service for the premises wiring.

11. At least one non-transitory computer-readable storage medium comprising computer-executable instructions that, when executed by at least one processor, perform a method of processing values representing a frequency spectrum on a line, the method comprising:
with at least one processor, determining whether a low frequency variation exists in the frequency spectrum; and
based, at least in part, on the determination that a low frequency variation exists, indicating a pre-qualification state of the line for providing a high speed data service.

12. The at least one non-transitory computer-readable storage medium of claim 11, wherein the pre-qualification state is selected from a set that comprises: qualified and not qualified.

13. The at least one non-transitory computer-readable storage medium of claim 12, wherein the set further comprises: the line has an un-terminated extension.

14. The at least one non-transitory computer-readable storage medium of claim 12, wherein the high speed data service is VDSL2 service.

15. The at least one non-transitory computer-readable storage medium of claim 12, wherein the frequency spectrum has a bandwidth and determining whether the low frequency variation exists comprises performing a low pass filtering operation on the frequency spectrum to segregate variations with a period of greater than 1/20^{th} the bandwidth.

16. A test device configured to pre-qualify a telephone line for a high speed data service, the device comprising:
at least one input port configured for connection to the telephone line of the type that exists within a customer premises;
a measurement section configured to measure a signal on a line connected at the input port;
at least one processor configured to:
compute a signal representative of low frequency variation of a frequency spectrum of the measured signal; and
generate an indication of a pre-qualification state of the line for providing a high speed data service based, at least in part, on the computed signal.

17. The test device of claim 16, wherein:
the measurement section has a bandwidth exceeding 30 MHz.

18. The test device of claim 16, wherein:
the low frequency variation comprises frequency components with a period of longer than 1/20^{th} of the bandwidth.

19. The test device of claim 16, wherein:
the at least one processor is further configured to transmit the indication of the pre-qualification state of the line to a computerized device operated by a provider of the high speed data service.

20. The test device of claim 16, wherein the at least one input port comprises a standard telephone connector.
